(19) United States
(12) Patent Application Publication
(10) Pub. No.: US 2026/0015471 A1
(43) Pub. Date: Jan. 15, 2026

(54) METHOD FOR PREPARING CONTROLLABLY CROSS-LINKED GRAPHENE-MODIFIED NATURAL RUBBER BASED ON AQUEOUS PHASE SYNERGISTIC AGGREGATING PRECIPITATING PROCESS

(71) Applicants: NORTH UNIVERSITY OF CHINA, Taiyuan (CN); SHANXI ZHONGBEI NEW MATERIAL TECHNOLOGY CO., LTD., Taiyuan (CN)

(72) Inventors: Yaqing LIU, Taiyuan (CN); Shuaishuai CHENG, Taiyuan (CN); Guizhe ZHAO, Taiyuan (CN)

(21) Appl. No.: 19/336,553

(22) Filed: Sep. 23, 2025

(51) Int. Cl. C08J 3/26; C08K 3/04; C08K 3/06; C08K 3/22; C08K 5/09; C08K 5/45

(52) U.S. Cl. CPC C08J 3/26; C08K 3/042; C08K 3/06; C08K 3/22; C08K 5/09; C08K 5/45; C08J 2307/02; C08K 2003/2296

(57) ABSTRACT

A method for preparing a controllably cross-linked graphene-modified natural rubber (NR) based on an aqueous phase synergistic aggregating precipitating process is provided. A nano-sulfur/vulcanization accelerator@graphene oxide (GO) aqueous dispersion is prepared by loading nano-sulfur and a vulcanization accelerator on GO. A nano-sulfur/vulcanization accelerator@GO-modified NR masterbatch and a GO-modified NR masterbatch are respectively prepared by means of the aqueous phase synergistic aggregating precipitating process. Finally, the controllably cross-linked graphene-modified NR is produced by vulcanization. The nano-sulfur/vulcanization accelerator@GO results in improvement of vulcanization efficiency, as well as cross-linking density and uniformity of a cross-linking network of the obtained vulcanized rubber by enhancing dispersibility of the vulcanizing agent and the vulcanization accelerator and increasing their contact area with the natural rubber matrix, while controlling the cross-linking sites. Meanwhile, the NR vulcanizate is endowed with low heat generation performance by reducing a filler-filler friction and a filler-matrix friction.

### CROSS-REFERENCE TO RELATED APPLICATIONS

This application claims the benefit of priority from Chinese Patent Application No. 202411001169.9, filed on Jul. 25, 2024. The content of the aforementioned application, including any intervening amendments made thereto, is incorporated herein by reference in its entirety.

### TECHNICAL FIELD

This application relates to graphene and functional rubber composites, and more particularly to a method for preparing a controllably cross-linked graphene-modified natural rubber based on an aqueous phase synergistic aggregating precipitating process.

### BACKGROUND

Natural rubber (NR) has been widely used in various fields due to its outstanding mechanical properties, tear resistance and elasticity. However, despite years of research and application, extending the service life of NR and improving the operational stability of NR remain challenging tasks. As a poor conductor of heat, thermal damage is a major factor that cannot be ignored in the performance degradation of NR. Therefore, reducing the heat generation of rubber products has become one of the most critical challenges. Developing novel rubber composite materials and their preparation technologies to reduce heat generation can not only enhance the stability and durability of rubber products but also further optimize other properties.

Additionally, NR itself has relatively low strength, making it essential to improve its strength to expand application fields and scope. Incorporating nanofillers with small particle size and large specific surface area has become one of the most effective and convenient approaches to enhance the strength of NR. Clay, carbon black, carbon nanotubes, graphene and derivatives thereof are ideal fillers. Particularly, graphene oxide (GO), one of the graphene derivatives, has gained extensive application due to the excellent high thermal conductivity, electrical conductivity and mechanical strength. Moreover, the abundant oxygen-containing functional groups on the surface of GO provide more possibilities for improving the performance and imparting functionality to NR.

For tires molded from nanofiller-reinforced NR, the mechanical damage, fatigue damage and thermal damage during tire rolling are the main causes of reduced service life. Among these factors, reducing the heat generation of NR is particularly important. From the perspective of the material itself, the heat generation of rubber primarily originates from the filler-filler friction, filler-matrix friction and matrix-matrix friction. Thus, reducing friction plays a pivotal role in decreasing heat generation and thereby extending the service life of rubber tires. The friction in rubber composites is mainly related to two factors, i.e., the dispersion of fillers and the interfacial interaction between rubber and fillers. Better dispersion and stronger interfacial interaction between fillers and rubber result in less friction and lower heat generation.

### SUMMARY

An object of the disclosure is to provide a method for preparing a controllably cross-linked graphene-modified natural rubber (NR) based on an aqueous phase synergistic aggregating precipitating process, so as to improve low heat generation performance of NR, and further extend the service life of tires by reducing a thermal damage of NR tires under driving conditions.

In order to achieve the above object, the following technical solutions are adopted.

This application provides a method for preparing a controllably cross-linked graphene-modified NR based on an aqueous phase synergistic aggregating precipitating process, comprising:
(1) adding an acidic solution and a sulfur source solution to an aqueous dispersion of a first graphene oxide (GO) followed by reaction at a first preset temperature for a first preset time to obtain a nano-sulfur-loaded GO aqueous dispersion; sequentially adding deionized water and an ethanol solution of a first vulcanization accelerator to the nano-sulfur-loaded GO aqueous dispersion followed by reaction at a second preset temperature for a second preset time and centrifugation to obtain a precipitate; and dispersing the precipitate in deionized water to obtain a nano-sulfur/vulcanization accelerator@GO aqueous dispersion;
(2) adding deionized water to a first NR latex followed by mixing to obtain a first latex aqueous dispersion system, adding the e nano-sulfur/vulcanization accelerator@GO aqueous dispersion to the first latex aqueous dispersion system followed by mixing to obtain a first mixture system, adding a first flocculant to the first mixture system for first flocculation to obtain a first crude rubber, wherein the first flocculation occurs due to reduction of repulsion between negative charges of NR particles in the first mixture system that keeps the first mixture system stable, and the NR particles in the first mixture system whose protection layers are damaged and the nano-sulfur/vulcanization accelerator@GO further undergo mutual adsorption by means of interaction to form first bound particles, and then the first bound particles are orderly aggregated and co-precipitated from a first aqueous phase to obtain the first crude rubber; and
water washing and drying the first crude rubber for multiple times to obtain a nano-sulfur/vulcanization accelerator@GO-modified NR masterbatch; wherein in the nano-sulfur/vulcanization accelerator@GO, a weight ratio of nano-sulfur to the first vulcanization accelerator to the first GO is 3-7:3-7:10;
(3) adding deionized water to a second NR latex followed by mixing to obtain a second latex aqueous dispersion system, adding an aqueous dispersion of a second GO to the second latex aqueous dispersion system followed by mixing to obtain a second mixture system, adding a second flocculant to the second mixture system for second flocculation to obtain a second crude rubber, wherein the second flocculation occurs due to reduction of repulsion between negative charges of NR particles in the second mixture system that keeps the second mixture system stable, and the NR particles in the second mixture system whose protection layers are damaged and the second GO further undergo mutual adsorption by means of interaction to form second bound particles, and then the second bound particles are orderly aggregated and co-precipitated from a second aqueous phase to obtain the second crude rubber; and
water washing and drying the second crude rubber for multiple times to obtain a GO-modified NR masterbatch; and
(4) subjecting the GO-modified NR masterbatch to internal mixing in an internal mixer at a third preset temperature for a third preset time to obtain a first rubber mixture, and during the internal mixing, adding a rubber additive and a reinforcing filler to the internal mixer;
cooling the first rubber mixture to room temperature followed by open milling at a fourth preset temperature for a fourth preset time on an open mill, and during the open milling, adding a vulcanizing agent and the nano-sulfur/vulcanization accelerator@GO-modified NR masterbatch to the open mill followed by mixing to obtain a second rubber mixture; subjecting the second rubber mixture to mill run until there are no bubbles in the second rubber mixture, and standing at a fifth temperature for a fifth preset time to obtain a rubber compound; and
transferring the rubber compound into a mold followed by vulcanization at a preset pressure and a sixth preset temperature for a sixth preset time, so as to obtain the controllably cross-linked graphene-modified NR, wherein enhancing dispersibility of the vulcanizing agent and the first vulcanization accelerator and increasing contact area with a NR matrix while controlling a cross-linking site improve a vulcanization efficiency, a cross-linking density, and cross-linking network uniformity of the controllably cross-linked graphene-modified NR, and a low heat generation performance is achieved by reducing a filler-filler friction and a filler-matrix friction in the controllably cross-linked graphene-modified NR;
wherein a weight ratio of NR in the controllably cross-linked graphene-modified NR to a sum of the rubber additive and the first vulcanization accelerator to the reinforcing filler to the GO contained in the nano-sulfur/vulcanization accelerator@GO is 100:8-15:30-90:0.4-2.

In some embodiments, the rubber additive comprises an anti-aging agent, an antioxidant, a second vulcanization accelerator, an activator, and a softener in a weight ratio of 2:2:1.3-1.85:5:2;

In some embodiments, each of the first vulcanization accelerator and the second vulcanization accelerator is selected from the group consisting of N-tert-butyl-2-benzothiazolesulfenamide, N-cyclohexyl-2-benzothiazole sulfenamide, N-(oxydiethylene)-2-benzothiazole sulfonamide, and a combination thereof; the anti-aging agent is selected from the group consisting of 2,6-di-tert-butyl-4-methylphenol, poly (l,2-dihydro-2,2,4-trimethylquinoline), 2-mercaptobenzimidazole, and a combination thereof; the antioxidant is selected from the group consisting of N-(1,3-dimethylbutyl)-N′-phenyl-1,4-phenylenediamine, p-phenylaniline, dilauryl thiodipropionate, and a combination thereof; the activator is selected from the group consisting of zinc gluconate, zinc oxide, magnesium oxide, and a combination thereof; the softener is selected from the group consisting of stearic acid, dibutyl titanate, dioctyl adipate, and a combination thereof; the vulcanizing agent is sulfur; and the reinforcing filler is a carbon black.

In some embodiments, the acidic solution is prepared using a material selected from the group consisting of dilute hydrochloric acid, ascorbic acid, formic acid, citric acid, sulfuric acid, and a combination thereof; the sulfur source solution is prepared using a material selected from the group consisting of sodium sulfate, sodium thiosulfate, sodium persulfate, sodium thiosulfate pentahydrate, and a combination thereof; and the first preset temperature ranges from the room temperature to 50° C.; the first preset time is 1-5 h; the second preset temperature is 50-90° C.; and the second preset time is 1-4 h.

In some embodiments, a concentration of the aqueous dispersion of the first GO is 1-10 mg/mL; a concentration of the acidic solution is 0.01-0.1 mol/L; a concentration of the sulfur source solution is 100-200 mg/mL; a concentration of the ethanol solution of the first vulcanization accelerator is 20-60 mg/mL; a concentration of the nano-sulfur/vulcanization accelerator@GO aqueous dispersion is 1-10 mg/mL.

In some embodiments, each of the first latex aqueous dispersion system and the second latex aqueous dispersion system has a concentration of 15-35 wt. %.

In some embodiments, the first flocculant is selected from the group consisting of a calcium chloride solution, a formic acid solution, a hydrochloric acid solution, a sodium chloride solution, a potassium chloride solution, and a combination thereof; and the first crude rubber is dried at 40-80° C.

In some embodiments, a concentration of the aqueous dispersion of the second GO is 1-10 mg/mL; the second flocculant is selected from the group consisting of a calcium chloride solution, a formic acid solution, a hydrochloric acid solution, a sodium chloride solution, a potassium chloride solution, and a combination thereof; and the second crude rubber is dried at 40-80° C.

In some embodiments, the third preset temperature is 100-120° C.; the third preset time is 10-16 min; the fourth preset temperature is 50-70° C.; the fourth preset time is 10-15 min; the fifth preset temperature is the room temperature; the fifth preset time is 20-30 h; the sixth preset temperature is 140-160° C.; the preset pressure is 10-20 MPa; and the sixth preset time is 5-15 min.

Compared with the prior art, the present disclosure has the following beneficial effects.
1. The nano-sulfur/vulcanization accelerator@GO, which is simultaneously loaded nano-sulfur and vulcanization accelerator and is prepared through the simplified process of the present disclosure, can undergo a cross-linking reaction with rubber macromolecules. The nano-sulfur/vulcanization accelerator@GO has the advantages of effectively improving the vulcanization efficiency of NR and enhancing the low heat generation property of the vulcanized rubber.
2. The nano-sulfur/vulcanization accelerator@GO of the present disclosure results in improvement of vulcanization efficiency, as well as cross-linking density and uniformity of the cross-linking network of the obtained vulcanized rubber by enhancing the dispersibility of the vulcanizing agent and the vulcanization accelerator and increasing their contact area with the natural rubber matrix, while controlling the cross-linking sites. Meanwhile, the NR vulcanizate is endowed with low heat generation performance by reducing the filler-filler friction and filler-matrix friction.

### BRIEF DESCRIPTION OF THE DRAWINGS

The accompanying drawings, which are incorporated into and constitute a part of this specification, are intended to illustrate the embodiments of the disclosure, and are used for explaining the principles of the disclosure in conjunction with the specification.

In order to illustrate the technical solutions in the embodiments of the present disclosure or in the prior art more clearly, the drawings needed in the description of embodiments or the prior art will be briefly introduced below. Obviously, for those of ordinary skill in the art, other drawings can be obtained based on these drawings without exerting creative efforts.

Fig. 1a is a scanning electron microscopy (SEM) image of nano-sulfur@graphene oxide in Example 1 of the present disclosure;

FIG. 1b is an SEM image of commercial sublimed sulfur in the prior art;

FIGS. 2a-e are SEM images of brittle fracture surfaces of modified natural rubber (NR) composites prepared in Examples 1-2 of the present disclosure and Comparative Examples 1-3, respectively; and

FIG. 3 shows vulcanization curves of the modified NR composites prepared in Examples 1-2 of the present disclosure and Comparative Examples 1-3, respectively.

### DETAILED DESCRIPTION OF EMBODIMENTS

In order to make the purpose, technical solutions and advantages of the embodiments of the present disclosure clearer, the technical solutions in the embodiments of the present disclosure will be clearly and completely described below. It should be noted that, as long as there is no contradiction, the embodiments of the present disclosure and the features therein can be combined with each other.

### Example 1

Provided herein was a method for preparing a controllably cross-linked graphene-modified natural rubber (NR) based on an aqueous phase synergistic aggregating precipitating process, which included the following steps.
Step (1) A 0.1 mol/L hydrochloric acid solution and a 160 mg/mL sodium thiosulfate pentahydrate solution were added to a 2.5 mg/mL graphene oxide (GO) aqueous dispersion, and reacted at room temperature (25° C.) for 3 h, so as to obtain a nano-sulfur@GO aqueous dispersion. A volume ratio of the GO aqueous dispersion to the hydrochloric acid solution to the sodium thiosulfate pentahydrate solution was 8:6:1.
Step (2) The nano-sulfur@GO aqueous dispersion was adjusted to a concentration of 2.64 mg/mL, then added with a 40 mg/mL ethanol solution of N-cyclohexyl-2-benzothiazole sulfenamide (CZ) as a vulcanization accelerator, and reacted at 70° C. for 2 h to obtain a reaction mixture. A volume ratio of the nano-sulfur@GO aqueous dispersion to the ethanol solution of CZ was 2:1. The reaction mixture was centrifugated at 6000 rpm to obtain a precipitate. The precipitate was dispersed in deionized water to obtain a 2.77 mg/mL nano-sulfur/vulcanization accelerator@GO aqueous dispersion.
Step (3) Deionized water was added to a first NR latex to obtain a first latex aqueous dispersion system with a concentration of 30 wt. %. Then, the 2.77 mg/mL nano-sulfur/vulcanization accelerator@GO aqueous dispersion was added to the first latex aqueous dispersion system and mechanically stirred for 30 min. A 10 wt. % calcium chloride solution was added for latex flocculation to obtain a first crude rubber. A volume ratio of the first latex aqueous dispersion system to the nano-sulfur/vulcanization accelerator@GO aqueous dispersion to the calcium chloride solution was 167:100:30. The first crude rubber was repeatedly soaked in water and dehydrated, then dried at 60° C. to a constant weight, so as to obtain a nano-sulfur/vulcanization accelerator@GO-modified NR masterbatch with a nano-sulfur/vulcanization accelerator@GO content of 1.04 wt. %, where a weight ratio of nano-sulfur to the vulcanization accelerator to the GO was 56:52:100.
Step (4) Deionized water was added to a second NR latex to obtain a second latex aqueous dispersion system with a concentration of 30 wt. %. Then, a 5 mg/mL GO aqueous dispersion was added to the second latex aqueous dispersion system and mechanically stirred for 30 min. A 10 wt. % calcium chloride solution was added for latex flocculation to obtain a second crude rubber. A volume ratio of the second latex aqueous dispersion system to the GO aqueous dispersion to the calcium chloride solution was 167:50:30. The second crude rubber was soaked in water and dehydrated repeatedly, then dried at 60° C. to a constant weight, so as to obtain a GO-modified NR masterbatch with a GO content of 0.5 wt. %.

Step (5) The GO-modified NR masterbatch containing 80 parts per hundred rubber (PHR) of NR was subjected to internal mixing in an internal mixer at 110° C. for 4 min. 2 PHR of N-(1,3-dimethylbutyl)-N′-phenyl-1,4-phenylenediamine (antioxidant 4020), 2 PHR of poly(l,2-dihydro-2,2,4-trimethylquinoline) (anti-aging agent RD) and 1.74 PHR of vulcanization accelerator CZ were added to the internal mixer, and the internal mixing was continued for 4 min. 5 PHR of ZnO as an activator, 2 PHR of stearic acid as a softener and 18 PHR of a carbon black N330 were added to the internal mixer, and the internal mixing was continued for a further 4 min. Then, 17 PHR of the carbon black N330 was added to the internal mixer, and the internal mixing was continued for a further 4 min to obtain a first rubber mixture. The rubber mixture was discharged, cooled to room temperature, and subjected to open milling at 60° C. for 10 min on an open mill. During the open milling, the nano-sulfur/vulcanization accelerator@GO modified NR masterbatch containing 20 PHR of NR and 1.72 PHR of sulfur were added to the open mill for uniform mixing to obtain a second rubber mixture. The second rubber mixture was subjected to mill run until there are no bubbles in the second rubber mixture and standing for 24 h to obtain a rubber compound. The rubber compound was transferred into a mold and vulcanized at 15 MPa and 150° C. for 6 min according to the time to reach 90% vulcanization (t_{c}90), so as to obtain the controllably cross-linked graphene-modified NR, where the t_{c}90 was measured by a rubber process analyzer.

### Example 2

The preparation method provided herein was basically the same as that in Example 1, except that the 2.77 mg/mL nano-sulfur/vulcanization accelerator@GO aqueous dispersion was replaced with a 5.54 mg/mL nano-sulfur/vulcanization accelerator@GO aqueous dispersion; and in step (5), amounts of the sulfur and the vulcanization accelerator CZ were 1.44 PHR and 1.48 PHR, respectively.

### Comparative Example 1

Provided herein was a method for preparing a GO-modified NR, where both the preparation process and the content of each component in the obtained modified NR composite were basically the same as those in Example 1 (see Table 1). The method included the following steps.
Step (1) was the same as step (4) in Example 1.
Step (2) was basically the same as step (5) in Example 1, except that the nano-sulfur/vulcanization accelerator@GO-modified NR masterbatch was not added, and amounts of the vulcanization accelerator CZ and the sulfur were both 2 PHR.

### Comparative Example 2

Provided herein was a method for preparing a vulcanization accelerator@GO-modified NR, where both the preparation process and the content of each component in the obtained modified NR composite were basically the same as those in Example 1 (see Table 1). The method included the following steps.
Step (1) was basically the same as step (2) in Example 1, except that the nano-sulfur@GO was replaced with GO.
Step (2) was basically the same as step (3) in Example 1, except that the nano-sulfur/vulcanization accelerator@GO was replaced with vulcanization accelerator@GO.
Step (3) was the same as step (4) in Example 1.
Step (4) was basically the same as step (5) in Example 1, except that the nano-sulfur/vulcanization accelerator@GO was replaced with vulcanization accelerator@GO, and an amount of the sulfur was 2 PHR.

### Comparative Example 3

Provided herein was a method for preparing a nano-sulfur@GO-modified NR, where both the preparation process and the content of each component in the obtained modified NR composite were basically the same as those in Example 1 (see Table 1).

The method included the following steps.
Step (1) was the same as step (1) in Example 1.
Step (2) was basically the same as step (3) in Example 1, except that the nano-sulfur/vulcanization accelerator@GO was replaced with nano-sulfur@GO.
Step (3) was the same as step (4) in Example 1.
Step (5) was basically the same as step (5) in Example 1, except that the nano-sulfur/vulcanization accelerator@GO was replaced with nano-sulfur@GO, and an amount of the vulcanization accelerator CZ was 2 PHR.

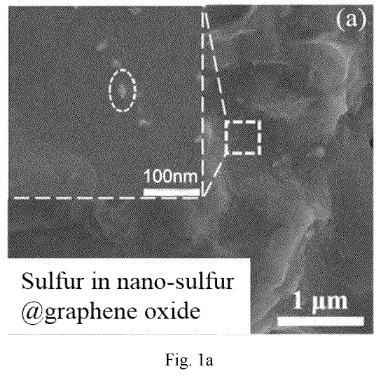

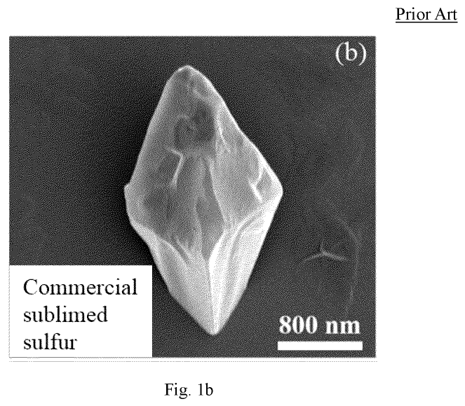

As shown in FIGS. 1a-b, in the nano-sulfur@GO particles prepared by the present application, in-situ deposited sulfur exists at the nanoscale (approximately 50-100 nm), while the commercial sublimed sulfur exists at the micrometer scale (approximately 1-10 μm).

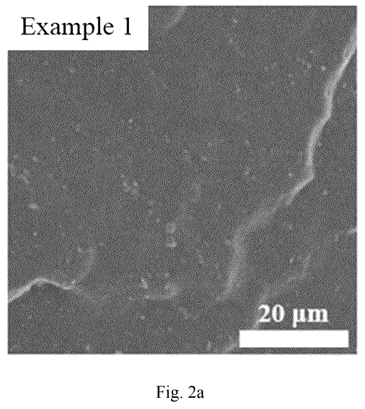

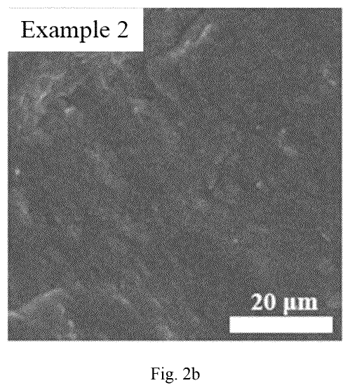

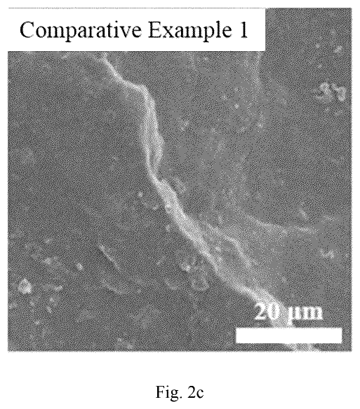

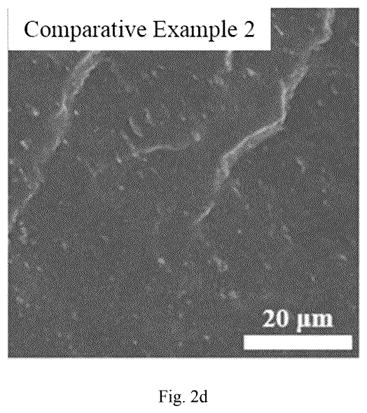

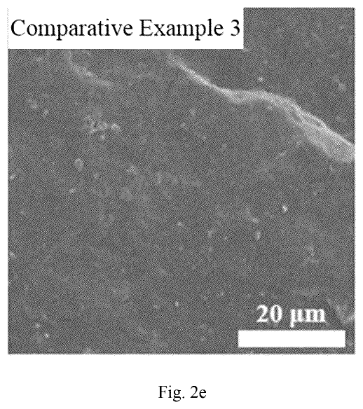

As shown in FIGS. 2a-e, compared with Comparative Examples 1-3, fillers in the rubber composites prepared in Examples 1-2 of the present disclosure are dispersed more uniformly.

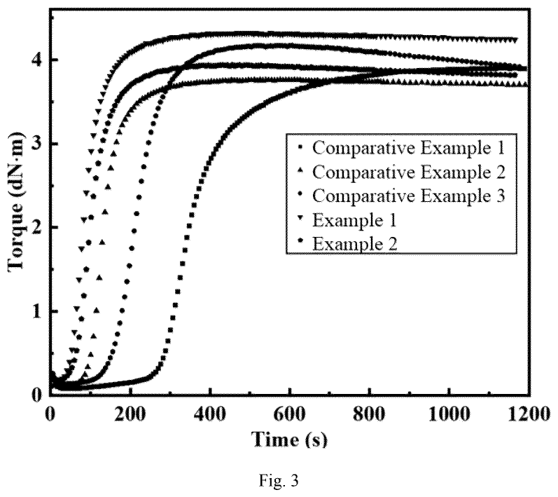

As shown in FIG. 3, compared with Comparative Examples 1-3, Examples 1-2 of the present disclosure exhibit a faster vulcanization rate during the thermal vulcanization stage and the largest MH-ML value (maximum torque value minus minimum torque value). These indicated that the nano-sulfur/vulcanization accelerator@GO of the present disclosure can indeed significantly enhance the cross-linking density and vulcanization efficiency of NR.

Performance tests were conducted on the NR composites obtained in Examples 1-2 and Comparative Examples 1-3. The test standard for tensile performance was GB/T 528-2009, with a tensile rate of 500 mm/min. The test standard for tear performance was GB/T 529-2008. The test standard for hardness was GB/T531.1-2008. The test standard for abrasion resistance performance was GB/T 9867-2008. The test standard for cross-linking density was GB/T 533-2008. The test standard for heat generation performance was GB/T 1687.1-2016. Table 2 shows the test results.

TABLE 1
Formulation of Examples 1-2 and Comparative Examples 1-3

| | Comparative | Comparative | Comparative | Example | Example |
|---|---|---|---|---|---|
| Sample | Example 1 | Example 2 | Example 3 | 1 | 2 |
| NR (PHR) | 100 | 100 | 100 | 100 | 100 |
| 4020(PHR) | 2 | 2 | 2 | 2 | 2 |
| RD (PHR) | 2 | 2 | 2 | 2 | 2 |
| ZnO (PHR) | 5 | 5 | 5 | 5 | 5 |
| Stearic acid | 2 | 2 | 2 | 2 | 2 |
| (PHR) | | | | | |
| Carbon black | 38 | 38 | 38 | 38 | 38 |
| N330 (PHR) | | | | | |
| CZ (PHR) | 2 | 1.72 | 2 | 1.74 | 1.48 |
| CZ in CZ@GO | — | 0.28 | — | — | — |
| (PHR) | | | | | |
| CZ in nano- | — | — | — | 0.26 | 0.52 |
| sulfur/CZ@GO | | | | | |
| (PHR) | | | | | |
| Sulfur in nano- | — | — | 0.29 | — | — |
| sulfur@GO | | | | | |
| (PHR) | | | | | |
| Sulfur in nano- | — | — | — | 0.28 | 0.56 |
| sulfur/CZ@GO | | | | | |
| (PHR) | | | | | |
| Sulfur (PHR) | 2 | 2 | 1.71 | 1.72 | 1.44 |
| GO (PHR) | 0.5 | — | — | — | |
| GO in CZ@GO | — | 0.5 | — | — | |
| (PHR) | | | | | |
| GO in nano- | — | — | 0.5 | — | |
| sulfur@GO | | | | | |
| (PHR) | | | | | |
| GO in nano- | — | — | — | 0.5 | 1 |
| sulfur/CZ@GO | | | | | |
| (PHR) | | | | | |

TABLE 2
Comprehensive performances of NR composites obtained
in Examples 1-2 and Comparative Examples 1-3

| | Comparative | Comparative | Comparative | Example | Example |
|---|---|---|---|---|---|
| Sample | Example 1 | Example 2 | Example 3 | 1 | 2 |
| Tensile strength | 25.08 | 26.2 | 27.0 | 28.3 | 27.8 |
| (MPa) | | | | | |
| Tear strength | 71.2 | 78.5 | 84.3 | 97.5 | 92.4 |
| (N/mm) | | | | | |
| Hardness (HA) | 60.5 | 61 | 62 | 63 | 66.5 |
| Abrasion volume | 94.3 | 85.5 | 88.2 | 82.9 | 83.4 |
| (mm³) | | | | | |
| Cross-linking | 6.032 | 7.061 | 7.445 | 7.772 | 7.332 |
| density (*10⁻⁴) | | | | | |
| Heat-generation | 12.2 | 10.5 | 10.2 | 9.7 | 9.5 |
| value (° C.) | | | | | |

As shown in Table 2, tensile strength, tear strength, hardness, heat generation performance under dynamic compression, abrasion resistance, and cross-linking density of the controllably cross-linked graphene-modified NR composites obtained in Examples 1-2 of the present disclosure are significantly improved compared with the GO-modified NR composites of Comparative Examples 1-3.

The embodiments described above are merely illustrative of the present application to enable those skilled in the art to understand or implement the present disclosure, instead of limiting the scope of the present application. Although the disclosure has been described in detail with reference to the above embodiments, various variations, replacements and modifications can still be made by those skilled in the art to the technical solutions recited in the above embodiments. It should be understood that those modifications, variations and replacements made without departing from the spirit of the disclosure shall fall within the scope of the disclosure defined by the appended claims.

What is claimed is:

1. A method for preparing a controllably cross-linked graphene-modified natural rubber (NR) based on an aqueous phase synergistic aggregating precipitating process, comprising:
(1) adding an acidic solution and a sulfur source solution to an aqueous dispersion of a first graphene oxide (GO) followed by reaction at a first preset temperature for a first preset time to obtain a nano-sulfur-loaded GO aqueous dispersion; sequentially adding deionized water and an ethanol solution of a first vulcanization accelerator to the nano-sulfur-loaded GO aqueous dispersion followed by reaction at a second preset temperature for a second preset time and centrifugation to obtain a precipitate; and
dispersing the precipitate in deionized water to obtain a nano-sulfur/vulcanization accelerator@GO aqueous dispersion;
(2) adding deionized water to a first NR latex followed by mixing to obtain a first latex aqueous Is dispersion system, adding the nano-sulfur/vulcanization accelerator@GO aqueous dispersion to the first latex aqueous dispersion system followed by mixing to obtain a first mixture system, adding a first flocculant to the first mixture system for first flocculation to obtain a first crude rubber, wherein the first flocculation occurs due to reduction of repulsion between negative charges of NR particles in the first mixture system that keeps the first mixture system stable, and the NR particles in the first mixture system whose protection layers are damaged and the nano-sulfur/vulcanization accelerator@GO further undergo mutual adsorption by means of interaction to form first bound particles, and then the first bound particles are orderly aggregated and co-precipitated from a first aqueous phase to obtain the first crude rubber; and
water washing and drying the first crude rubber for multiple times to obtain a nano-sulfur/vulcanization accelerator@GO-modified NR masterbatch; wherein in the nano-sulfur/vulcanization accelerator@GO, a weight ratio of nano-sulfur to the first vulcanization accelerator to the first GO is 3-7:3-7:10;
(3) adding deionized water to a second NR latex followed by mixing to obtain a second latex aqueous dispersion system, adding an aqueous dispersion of a second GO to the second latex aqueous dispersion system followed by mixing to obtain a second mixture system, adding a second flocculant to the second mixture system for second flocculation to obtain a second crude rubber, wherein the second flocculation occurs due to reduction of repulsion between negative charges of NR particles in the second mixture system that keeps the second mixture system stable, and the NR particles in the second mixture system whose protection layers are damaged and the second GO further undergo mutual adsorption by means of interaction to form second bound particles, and then the second bound particles are orderly aggregated and co-precipitated from a second aqueous phase to obtain the second crude rubber; and
water washing and drying the second crude rubber for multiple times to obtain a GO-modified NR masterbatch; and
(4) subjecting the GO-modified NR masterbatch to internal mixing in an internal mixer at a third preset temperature for a third preset time to obtain a first rubber mixture, and during the internal mixing, adding a rubber additive and a reinforcing filler to the internal mixer;
cooling the first rubber mixture to room temperature followed by open milling at a fourth preset temperature for a fourth preset time on an open mill, and during the open milling, adding a vulcanizing agent and the nano-sulfur/vulcanization accelerator@GO-modified NR masterbatch to the open mill followed by mixing to obtain a second rubber mixture; subjecting the second rubber mixture to mill run until there are no bubbles in the second rubber mixture, and standing at a fifth temperature for a fifth preset time to obtain a rubber compound; and
transferring the rubber compound into a mold followed by vulcanization at a preset pressure and a sixth preset temperature for a sixth preset time, so as to obtain the controllably cross-linked graphene-modified NR, wherein enhancing dispersibility of the vulcanizing agent and the first vulcanization accelerator and increasing contact area with a NR matrix while controlling a cross-linking site improve a vulcanization efficiency, a cross-linking density, and a cross-linking network uniformity of the controllably cross-linked graphene-modified NR, and a low heat generation performance is achieved by reducing a filler-filler friction and a filler-matrix friction in the controllably cross-linked graphene-modified NR;
wherein a weight ratio of NR in the controllably cross-linked graphene-modified NR to a sum of the rubber additive and the first vulcanization accelerator to the reinforcing filler to the GO contained in the nano-sulfur/vulcanization accelerator@GO is 100:8-15:30-90:0.4-2.

2. The method of claim 1, wherein the rubber additive comprises an anti-aging agent, an antioxidant, a second vulcanization accelerator, an activator, and a softener in a weight ratio of 2:2:1.3-1.85:5:2;
each of the first vulcanization accelerator and the second vulcanization accelerator is selected from the group consisting of N-tert-butyl-2-benzothiazole sulfenamide, N-cyclohexyl-2-benzothiazole sulfenamide, N-(oxydiethylene)-2-benzothiazole sulfonamide, and a combination thereof;
the anti-aging agent is selected from the group consisting of 2,6-di-tert-butyl-4-methylphenol, poly(l,2-dihydro-2,2,4-trimethylquinoline), 2-mercaptobenzimidazole, and a combination thereof;
the antioxidant is selected from the group consisting of N-(1,3-dimethylbutyl)-N′-phenyl-1,4-phenylenediamine, p-phenylaniline, dilauryl thiodipropionate, and a combination thereof;
the activator is selected from the group consisting of zinc gluconate, zinc oxide, magnesium oxide, and a combination thereof;
the softener is selected from the group consisting of stearic acid, dibutyl titanate, dioctyl adipate, and a combination thereof;
the vulcanizing agent is sulfur; and
the reinforcing filler is a carbon black.

3. The method of claim 1, wherein the acidic solution is prepared using a material selected from the group consisting of dilute hydrochloric acid, ascorbic acid, formic acid, citric acid, sulfuric acid, and a combination thereof;
the sulfur source solution is prepared using a material selected from the group consisting of sodium sulfate, sodium thiosulfate, sodium persulfate, sodium thiosulfate pentahydrate, and a combination thereof; and
the first preset temperature ranges from the room temperature to 50° C.; the first preset time is 1-5 h; the second preset temperature is 50-90° C.; and the second preset time is 1-4 h.

4. The method of claim 1, wherein a concentration of the aqueous dispersion of the first GO is 1-10 mg/mL; a concentration of the acidic solution is 0.01-0.1 mol/L; a concentration of the sulfur source solution is 100-200 mg/mL; a concentration of the ethanol solution of the first vulcanization accelerator is 20-60 mg/mL; a concentration of the nano-sulfur/vulcanization accelerator@GO aqueous dispersion is 1-10 mg/mL.

5. The method of claim 1, wherein each of the first latex aqueous dispersion system and the second latex aqueous dispersion system has a concentration of 15-35 wt. %.

6. The method of claim 1, wherein the first flocculant is selected from the group consisting of a calcium chloride solution, a formic acid solution, a hydrochloric acid solution, a sodium chloride solution, a potassium chloride solution, and a combination thereof; and
the first crude rubber is dried at 40-80° C.

7. The method of claim 1, wherein a concentration of the aqueous dispersion of the second GO is 1-10 mg/mL;
the second flocculant is selected from the group consisting of a calcium chloride solution, a formic acid solution, a hydrochloric acid solution, a sodium chloride solution, a potassium chloride solution, and a combination thereof; and
the second crude rubber is dried at 40-80° C.

8. The method of claim 1, wherein the third preset temperature is 100-120° C.; the third preset time is 10-16 min; the fourth preset temperature is 50-70° C.; the fourth preset time is 10-15 min; the fifth preset temperature is the room temperature; the fifth preset time is 20-30 h; the sixth preset temperature is 140-160° C.; the preset pressure is 10-20 MPa; and the sixth preset time is 5-15 min.
